(19) United States
(12) Patent Application Publication
(10) Pub. No.: US 2003/0185101 A1
(43) Pub. Date: Oct. 2, 2003

(54) Method and apparatus for spread spectrum distance measurement and for spread spectrum velocity profile measurement

(76) Inventor: Chester Wildey, Arlington, TX (US)

Correspondence Address: Chester Wildey, 2423 Homewood Trail, Arlington, TX, 76015, US

(21) Appl. No.: 10/396,907

(22) Filed: Mar. 25, 2003

Related U.S. Application Data
(60) Provisional application No. 60/367,184, filed on Mar. 26, 2002.

(51) Int. Cl. G01S 15/00

(52) U.S. Cl. 367/101

(57) ABSTRACT

This invention uses direct sequence spread spectrum modulation and a novel receiver method to implement ranging and Doppler measurement devices.

This application claims the benefit of provisional patent application No. 60/367,184.

### CROSS-REFERENCE TO RELATED APPLICATIONS

U.S. Pat. No. 5,335,545 Ultrasonic detector with frequency matching.

U.S. Pat. No. 5,418,758 Distance measurement system.

U.S. Pat. No. 4,890,266 Acoustic range finding system.

U.S. Pat. No. 6,176,830 Method and system for pre-determining spectral Doppler user parameters.

### STATEMENT REGARDING FEDERALLY SPONSORED RESEARCH OR DEVELOPMENT

N/A.

### REFERENCE TO SEQUENCE LISTING, A TABLE, OR A COMPUTER PROGRAM LISTING COMPACT DISK APPENDIX

N/A

### BACKGROUND OF THE INVENTION

This invention applies to the field of pulsed time of flight ranging systems and closely related pulsed time of flight/range gated Doppler flow profiling meters. The most common technologies used are Ultrasonic level measurement, Radar level measurement, and Time Domain Reflectometry along transmission lines (TDR). Each of these is summarized below, along with range gated Doppler flow, and limitations are discussed along with the improvements offered by the invention.

Ultrasonic level measurement is commonly used in industrial and municipal bulk material process measurements for inventory and control purposes. The main benefit of the technique is that no part of the measurement system contacts the product or material under measurement. This ensures no fouling of the system occurs, reducing maintenance and increasing reliability of the system, both the level measurement system and the process under control.

The most common operating principle in ultrasonic level measurement is monopulse time of flight reflectometry, wherein a burst of ultrasound is transmitted and the return echo captured and analyzed to provide information as to the distance to any reflecting targets (the speed of sound transmission in the medium being known or separately measured). One drawback of this technique is that during and immediately after the burst of sound is transmitted, the receiving apparatus is saturated and thus insensitive to any reflected energy. The result of this drawback is that the sensor has a blind area, or ‘dead zone’, or ‘ringdown area’, or ‘blanking distance’ beginning at the sensor face and extending 10 to 100 cm (or sometimes more depending on the particular device characteristics) along the axis of transmission. The sensor will not provide level measurement information for targets in this ‘dead zone’. As a result of this limitation the top area of tanks or bins utilizing these types of level gauges are unavailable for product, thus reducing the capacity of the system. The invention herein described addresses this problem and allows much more of the tank capacity to be used. Another drawback of these types systems is that since the time duration of the transmit pulse is short, and since the path losses for the return echo are usually large, the transmit pulse must be as of high an amplitude as possible. This large pulse requires a high power capability transducer and high voltage pulse generation electronics (typically on the order of several thousand volts), which increases cost and creates severe packaging constraints, especially for equipment intended to be used in a hazardous environment. By dramatically increasing the proportion of the time the unit transmits energy the direct sequence spread spectrum (dsss) system reduces the peak required power while keeping the average power high.

Similar methods are used for industrial radar level gauges, and the same disadvantages are encountered as for ultrasonic level gauges, namely blanking distance and high peak power levels. Additionally, for radar gauges the problem of timing is critical, since the speed of propagation for electromagnetic energy is much higher than for sound waves. It becomes difficult to capture the reflected energy with great enough time resolution to determine a precise target distance. With the dsss technique disclosed in this application, critical timing issues are not as much of a limiting a factor. Another advantage is that since the transmitted energy is spread over many frequencies, and has a spectral distribution very similar to noise, there is much less chance of generating interference and much relief from regulatory pressures. For example, many current radar level gauges my not be applied in non-conducting tanks due to the radar energy escaping into the environment. With a spread spectrum level gauge this problem is very slight or non-existent. Another typical problem with radar level gauges is measuring low dielectric constant materials, which give a very small echo. Since dsss offers processing gain, much smaller echoes may be detected.

Another ranging technique is TDR. In this technique a transmission line is placed in the tank, the material level creating a slight impedance change at the point of interface, thus reflecting a portion of the transmit pulse as for the radar gauge. This technique suffers from problems detecting low dielectric constant materials similar to the radar gauge.

Similar techniques are in use for profiling Doppler liquid flow meters wherein a pulse of sound energy is transmitted into a moving liquid medium and reflected off suspended particles or bubbles. The receiver is range gated (i.e. it samples only a narrow time segment of the entire reflected energy, corresponding to a desired target range) and the Doppler shift of the received energy along with the range gate delay timing gives the distance to and relative velocity of the suspended particles. Since the particles are assumed to move at the same velocity as the suspending liquid, and since the sensor is stationary, the result is determination of the velocity of the flow at a given range from the sensor face. By making a series of these measurements with different range gate timing delays, a profile of the liquid velocity may be generated. This along with the depth of the liquid and the known cross sectional area of the flow conduit, yields the flow rate. The flow rate is typically integrated over time to give the total volume of flow for some time period. The major limitation of this type of system is that the range gate has a limited width in time, thus limiting the precision to which the returned frequency may be determined. The spread spectrum Doppler flow meter eliminates this problem by continuously examining the Doppler shifts at a given range from the sensor. Since there is no limited time window, much less uncertainty in determining the Doppler shifted frequency is imposed, thereby allowing accurate calculation of the returned frequency shift and thus of the fluid velocity.

### BRIEF SUMMARY OF THE INVENTION

Dsss modulation techniques were first developed for military LPI (low probability of intercept) and jam-proof radar and communications systems. More recently this modulation technique has become common in cellular communications networks. This invention harnesses this technique to provide a low peak power, high dynamic range measurement system for industrial instrumentation. The benefits provided include higher SNR, better precision and accuracy in ranging Doppler applications, and the ability to use lower peak power transmissions.

### DETAILED DESCRIPTION OF THE INVENTION

In this system, the short pulse of traditional ultrasonic and radar level gauges is replaced by direct sequence spread spectrum (dsss) modulated energy. The receiver of the traditional system is replaced with a correlation type receiver. By varying the receiver index in the chip sequence with respect to the transmitted sequence, and by recording the correlation as a function of the chip index shift, it is possible to determine the energy reflected from targets vs target range.

Since typical low sidelobe direct sequences have a 20 to 30 dB attenuation vs. chip index, and since this is not enough dynamic range for most ranging applications, the dynamic range must be extended for a practical ranging system. The received sequence will consist of several versions of the original sequence, each phase shifted according to the echo delay, and each reduced in amplitude by the echo amplitude. Also each echo sequence will be filtered through the transmitting transducer, receiving transducer, and transmission medium. Given this, the best way to recover a high dynamic range echo profile is to record the received sequence, cross correlate it with a suitably filtered version of the original sequence, (to compensate for transmit and receive filtering of the original sequence—this corresponds to what would be received if there were only a single reflecting object in front of the sensor and may be measured directly with a suitable placed reference target, or if known beforehand may be programmed into the instruments database) record the phase delay and amplitude of the correlation, then mathematically remove that echo sequence from the received signal. This removes the sequence due to the largest echo from the received sequence, and therefore the interference of that sequence with sequences of other phase delays and lower amplitudes in the received signal. This process may be repeated, removing smaller and smaller echoes, building up the echo profile, with the ultimate limit being the ambient noise and the processing gain of the selected sequence. This can easily be 60 db below the noise floor for practical length sequences.

Given the high dynamic range, this type of system has extremely short dead zone, on the order of 5 mm as compared to many cm for traditional systems. Other advantages of this measurement technique over traditional methods are:

The measurement is continuous in nature. The receive chip sequence index may be manipulated to maintain constant measurement information on a specific portion of the span continuously. In pulsed time of flight systems, the entire measurement cycle must be completed in order to examine any portion of the measurement span. This allows the measurement results for the spread spectrum gauge for any given time period to be much more statistically significant (i.e. more certain) than pulsed time of flight measurements.

Since traditional systems operate on a single or only a few frequencies, dsss measurements, which use a multiplicity of frequencies, are more immune to interference from the environment, such as frequency dependent attenuation and frequency specific noise.

Dsss systems typically transmit energy at a lower average level than pulsed systems, leading to more efficient operation. This is especially important for low-powered instruments, such as those operated from battery power or those where power is at a premium as for intrinsically safe systems where the amount of stored and available energy is strictly regulated. For ultrasonic gauges, this lower energy transmission also offers advantages in less bulky (i.e. easier to install) and less expensive ultrasonic transducers. Lower powered operation is also important for loop powered instrumentation.

The dsss ultrasonic flow meter operates as does the range only unit with the addition of a frequency shifting function in the receivers offset chip sequence. The frequency shifting function is implemented by stretching the reference sequence to simulate a Doppler shift. By adjusting the frequency shift and the chip offset (i.e. phase delay) of the reference sequence in a nested loop manner, both range and Doppler shift may be determined. The echo identification and sequence removal then proceed as for the range only instrument. In effect, a two dimensional echo profile is generated, with echo amplitude plotted against both echo delay (i.e. target range) and Doppler shift (i.e. target velocity). The improvement over existing ranging Doppler meters is that since there is no arbitrary time limit on the sample to be analyzed for Doppler shift (i.e. no timerange window as in the currently available units), the range resolution and velocity precision are very much higher. This in turn leads to a more accurate and precise calculation of the flow.

Logical Flow of a Typical DSSS Level Gauge Implementation:

First the following signals are generated internal to the device:

A chip sequence of sufficient length to make the measurement unambiguous and with suitable orthogonal properties, hereafter called sequence A.

A replica of the chip sequence with a controlled delay (i.e., 1 step out of phase, 2 steps out of phase . . . to n steps out of phase where n is related to a low multiple of the length of the maximum span under measurement), hereafter called sequence B. Sequence B is modified according to the filter properties of the transmit/receive system so that cross correlation with the received sequence will reveal individual echo sequences.

Steps of operation:

1. Sequence A is used to modulate the transmitted energy (typically ultrasonic or radar energy, typically AMDSB modulation), which is then transmitted into the environment by suitable means.

2. Energy reflected from targets in the environment is recovered and recorded (it may also be demodulated directly with sequence B if high dynamic range is not required).

3. The reflected energy signal is correlated with sequence B and the largest echo phase delay and amplitude are determined. The result of this correlation yields the relative magnitude in sequence A of the energy reflected from a target with delay corresponding to the phase shift of sequence B.

3a. The echo sequence characterized in step 3 is removed from the received sequence. This may be by mathematical means as in the recorded signal, or may be in real time with discrete electronics.

4. The phase delay for sequence B is incremented and step 3 is repeated for all phase n in B.

4a. For the case of the Doppler flow meter, Sequence B is frequency shifted to move its spectrum by a fixed amount. This process is repeated with each repetition shifting the spectrum further. This process is carried out in nested loop fashion with the time delay (phase) changes in sequence B. This yields Doppler shift as well as range information.

5. One complete set of measurements (step 3 for each phase n of sequence B) comprises the basis for a complete measurement (i.e. a measurement profile or cross-correlation, or set of profiles or cross-correlations in the case of the Doppler flow meter) and is analogous to one transmit/receive cycle for a pulsed time of flight ranging system. This corresponds to an echo profile in traditional systems.

6. The resulting measurement profile is processed by digital or analog means to extract the desired target/range information (and in the case of the Doppler flowmeter target range/velocity information) as per prior art.

Many modifications and alternative embodiments of the invention will be apparent to those of ordinary skill in the art in view of the foregoing description of the preferred embodiment. This description is to be construed as illustrative only, and is for the purpose of teaching those skilled in the art the best mode of carrying out the invention. The details of the structure and method may be varied substantially without departing from the spirit of the invention, and the exclusive use of all modifications which come within the scope of the appended claims is reserved.

I claim:

1. A direct sequence spread spectrum ranging and Doppler measurement system using at least one transducer and incorporating echo processing for removing at least two echo sequences from the received sequence.

2. The reference signal for correlation with the received signal being modified by the filter characteristics of the transmit/receive system and transmission medium, and this signal being recorded in a database.

3. The direct sequence received signal being recorded to a database for later processing.

4. The cross correlation of the received signal and the reference signal being determined and recorded and the thus identified portion of the echo signal being subtracted from the received signal, this being repeated for smaller and smaller echo signals.

5. The cross correlation coefficient and phase delay determined in 4 being recorded to a database, the multiplicity of which constitute an echo profile.

6. The reference signal being modified to simulate a Doppler shift.

7. The cross correlation of the received signal and the Doppler shifted reference signal being determined and the thus identified portion of the echo signal being subtracted from the received signal, this being repeated for smaller and smaller echo signals.

8. The cross correlation coefficient and Doppler shift determined in 7 being recorded to a database, the multiplicity of which constitute a velocity profile for a given phase delay.

9. The data determined in 5 and 8 together creating an echo vs. range vs. Doppler shift database yielding information as to target range and velocity.
